(19) United States
(12) Patent Application Publication
(10) Pub. No.: US 2023/0354854 A1
(43) Pub. Date: Nov. 9, 2023

(54) HEART OF PALM PUREE

(71) Applicant: The Coca-Cola Company, Atlanta, GA (US)

(72) Inventors: Ray SCHACHT, Atlanta, GA (US); Laura HESS, Atlanta, GA (US); Brenda RUDAN, Atlanta, GA (US); Allen ZHU, Atlanta, GA (US); Kelly BROWN, Atlanta, GA (US); Juan Carlos MOTAMAYOR, Atlanta, GA (US); Marcelo PEREZ, Atlanta, GA (US)

(21) Appl. No.: 18/042,949

(22) PCT Filed: Aug. 24, 2021
(86) PCT No.: PCT/US2021/047358

§ 371 Date: Feb. 24, 2023

Related U.S. Application Data
(60) Provisional application No. 63/070,120, filed on Aug. 25, 2020.

(51) Int. Cl. A23L 2/02; A23L 2/68; A23L 5/10; A23L 5/20; A23L 19/00

(52) U.S. Cl. CPC A23L 2/02; A23L 2/68; A23L 5/13; A23L 5/25; A23L 19/09

(57) ABSTRACT

The present disclosure provides a puree of palm and process of making the puree. The puree of palm has reduced sugar, low calorie, various nutrients, and favorable sensory characteristic. The puree can by itself serve as a food product or can also be used as a functional component for beverages and foodstuffs.

This application is being filed on Aug. 25, 2021, as a PCT International Patent Application and claims priority to U.S. Provisional Patent Application Ser. No. 63/070,120, filed on Aug. 25, 2020, the entire disclosure of which is incorporated by reference in its entirety.

### INTRODUCTION

Consumable beverages such as juices and fruit purees are widely used in food industry because of their excellent sources of nutritional and beneficial values. For example, traditional beverages such as orange juice and banana puree are popular through generations of people. However, these traditional beverages even in a natural form are of high sugar content. Awareness of healthier diets and the risks of obesity and diabetes in global countries are moving consumers towards low calorie, low sugar beverages.

Many solutions have been provided by manufactures to produce beverages having low calorie and low sugar content. Many of the low-calorie beverages are primarily diluted juices with water, and include artificial flavoring, and/or ingredients from external sources. Such diluted juices lack a “natural flavor” and do not contain the original texture and/or taste profile and/or nutritional benefits of the original whole juices. Juice filtration processes and systems have also been developed to filter out sugars from the natural fruit juice. However, the filtered beverage may lose other beneficial ingredients during the filtration process, and issues of inconsistency with respect to quality, texture, nutritional balance, and taste profile remain unresolved. Low or non-calorie sweetener alternative to traditional high calorie sweeteners were also developed. These artificial or natural sweeteners are used to substitute the high calorie sweeteners comprising sucrose, fructose, and glucose. However, many low-calorie sweeteners can be expensive to produce and/or possess unfavorable taste characteristics and/or off-tastes, including but not limited to sweetness linger, delayed sweetness onset, negative mouth feels, bitter, metallic, cooling, astringent, and licorice-like tastes.

It is thus highly desirable for new and low-cost beverage or food product derived from natural plants, of high nutritional value and low calorie, with unique sensory and taste profile, and absent artificial or natural sweetener. It is also desirable for low calorie beverages or analogues thereof that resemble or substitute traditional high-calorie beverages.

### Heart of Palm Puree

### Summary of Disclosure

The present disclosure may be embodied in various exemplary and nonlimiting forms. In particular, this summary is intended merely to illuminate various embodiments of the invention and does not impose a limitation on the scope of the disclosure.

The present disclosure provides a food product derived from palm or a part thereof. In particular, the present food product is related to a puree or a paste or a flowable food or the like comprising particulate of a palm, preferably a heart of palm (or palm heart). In some embodiments, the puree is in a concentrate form, or is dried or substantially dried, or in a form or powder or flake with various moisture contents.

In some embodiments, the present food product consists essentially of a puree of palm, wherein the palm comprises a palm heart. The palm heart may comprise a major portion thereof, or a bottom portion thereof, or both. In preferred embodiments, the puree of palm is free or substantially free from a stem shell of palm.

The puree of palm according to the present disclosure can by itself serve as a finished food product to consumers, or alternatively be used as a functional component for other foodstuffs or beverages.

In some embodiments, the present puree has an average particle size from about 50 micron to about 1,000 micron, or from about 100 micron to about 800 micron, or from about 200 micron to about 600 micron, or from about 300 micron to about 500 micron.

In some embodiments, the present puree has a viscosity from about 100 centipoises to about 5,000 centipoises, or from about 300 centipoises to about 4,000 centipoises, or from about 600 centipoises to about 3,000 centipoises, or from about 900 centipoises to about 2,000 centipoises, or from about 1,500 centipoises to about 2,500 centipoises.

In some embodiments, the present puree comprises an acid selected from the group consisting of citric acid, acetic acid, fumaric acid, lactic acid, phosphoric acid, malic acid, tartaric acid, ascorbic acid, any derivatives thereof, or any combinations thereof.

In some embodiments, the present puree has a pH from about 2 to about 8, or from about 3 to about 7, or from about 4 to about 6, or from about 4 to about 5.

In some embodiments, the present puree has a Brix value from about 3° to about 10°, or from about 4° to about 9°, or from about 4° to about 7°, or from about 5° to about 7°.

In some embodiments, the present puree has a total carbohydrates from about 2 g/100 g to about 20 g/100 g, or from about 3 g/100 g to about 18 g/100 g, or from about 4 g/100 g to about 16 g/100 g, or from about 5 g/100 g to about 14 g/100 g, or from about 5 g/100 g to about 10 g/100 g, or from about 5 g/100 g to about 8 g/100 g, or from about 5 g/100 g to about 6 g/100 g.

In some embodiments, the present puree has a total fiber content from about 0.1 g/100 g to about 10 g/100 g, or from about 0.3 g/100 g to about 8 g/100 g, or from about 0.5 g/100 g to about 6 g/100 g, or from about 1 g/100 g to about 4 g/100 g, or from about 1.5 g/100 g to about 3 g/100 g, or from about 2 g/100 g to about 2.5 g/100 g.

In some embodiments, the present puree has a solid content from about 1 wt % to about 90 wt %, or from about 2 wt % to about 95 wt %, or from about 3 wt % to about 90 wt %, or from about 4 wt % to about 80 wt %, or from about 5 wt % to about 70 wt %, or from about 6 wt % to about 60 wt %, or from about 7 wt % to about 50 wt %, or from about 8 wt % to about 40 wt %, or from about 9 wt % to about 30 wt %, or from about 10 wt % to about 20 wt %.

In some embodiments, the present puree has a reduced vegetable flavor compared with raw palm.

In some embodiments, the present puree comprises an a functional ingredient selected from the group consisting of an electrolyte, a vitamin, a mineral, a metal ion, a probiotic, a prebiotic, a symbiotic, a phytonutrient, an amino acid, a protein, an antioxidant, a fatty acids, or combinations thereof.

In some embodiments, the present puree comprises ascorbic acid (Vitamin C).

In some aspects, the present disclosure relates to a process for making the puree described herein. In some embodiments, a process comprises providing a palm or a part thereof and subjecting the palm or the part thereof to a particle size reduction process, forming a puree thereof. In embodiments, the present process further comprises a homogenizing the formed puree. The palm or the part thereof may comprise a heart of palm, a bottom of palm, or both. The weight ratio of heart to bottom may vary. The size reduction and homogenization processes may include any mechanical technique common in the art of food preparation, including but not limited to grinding, knife grinding, plate grinding, milling, coarse milling, fine milling, colloidal milling, shearing, threshing, blending, mixing, shaking, agitation, homogenization, or combinations thereof.

In some embodiment, the present process further comprises providing a harvested palm comprising a heart and a shell surrounding the heart; removing the shell from the heart; and chopping the heart into pieces in about 0.5 inch to about 3 inches, prior to the size reduction process. In certain embodiments, the present process further comprises removing a bottom from the heart of palm.

In some embodiments, the present process further comprises treating the chopped palm pieces with boiling water for at least about 3 min, or at least about 5 min, or at least about 10 min, or at least about 15 min, or at least 20 min, or at least about 30 min. The boiling process may flush off unfavorable vegetable notes or volatile from the palm thereby eliminate or reduce vegetable flavor or taste in the puree or the beverage or foodstuff derived therefrom. In certain embodiments, the present process may further include a vacuum cooling or UHT processing to facilitate the evaporation or removal of vegetable volatiles.

In some embodiments, the present process further comprises treating the palm with an effective amount of an acid selected from the group consisting of citric acid, acetic acid, fumaric acid, lactic acid, phosphoric acid, malic acid, tartaric acid, ascorbic acid, any derivatives thereof, or any combinations thereof, and wherein the puree has a pH from about 2 to about 7, or from about 3 to about 6, or from about 4 to about 5.

In some embodiments, the present process further comprises adding a fruit juice into the palm, wherein the fruit is selected from the group consisting of citrus fruits, oranges, lemons, grapefruits, pomelos, limes, various true or hybrid cultivars thereof, and any combinations thereof.

In some embodiments, the present process further comprises treating the heart of palm with an effective amount of an enzyme preparation. The enzyme preparation may comprise a hemicellulolytic enzyme preparation, a pectolytic enzyme preparation, or both. Enzyme treatment may proceed at an elevated temperature.

In some embodiments, the present process further comprises concentrating the formed puree, thereby forming a puree concentrate thereof. Concentration can be achieved by heating or drying to reduce the moisture or water content of the puree. In some embodiments, the puree concentrate of palm has a higher Brix value compared with unconcentrated puree, in a range from about 5° to about 30°, or from about 10° to about 25°, or from about 15° to about 20°.

In some embodiments, the present process further comprises subjecting the palm to a juicing process, thereby forming a juice fraction and a pulp fraction; and subjecting the pulp fraction to the size reduction process, forming a puree of palm pulp.

In some aspects, the present disclosure relates to a puree of palm made by the process described herein.

In some aspects the present disclosure relates to a foodstuff or a beverage or a food product comprising the puree of palm described herein. The food product includes but is not limited to a snack food, a baked product, a pasta, a squeezable wet food, a spoonable wet food, a beverage, a dip, a whip, a sauce, a salad dressing, and combinations thereof. The baked product may include wafer(s), cracker(s), cookie(s), cake(s), bread(s), muffin(s), extruded snack(s), cookies, and biscuit(s).

### Definitions and Interpretations of Selected Terms

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “g” represents gram; “L” represents liter; “mg” represents “milligram (10⁻³ gram);” “mL” represents milliliter (10⁻³ liter); “cm” represents centimeter (10⁻² meter); “mm” represents millimeter (10⁻³ meter); “inch” is used as a length unit, and one inch equals to about 2.54 cm; “centipoise” or “cPs” or “cP” is used as a viscosity unit, and 1 cP=10⁻³ Pa·s=1 mPa·s.

The term “about” is used in conjunction with numeric values to include normal variations in measurements as expected by persons skilled in the art, and is understood have the same meaning as “approximately” and to cover a typical margin of error, such as ±10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The processes, methods, treatments, formulations, and compositions of the present disclosure may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed processes and compositions.

### BRIEF DESCRIPTION OF THE DRAWINGS

FIG. 1 illustrates an exemplary embodiment of a process for making a puree of palm and a puree concentrate thereof.

FIGS. 2A-2B illustrate the composition of an example of harvested raw palms, including various components of a raw palm and approximate composition of a raw palm; wherein % of each component is based on the total weight of the raw palm post-harvest.

FIG. 3 illustrates an example pilot scale process flow for the production of puree of palm heart according to Example 4, wherein the process flows from (1) milling in food processor, Robot Coupe to (2A) IKA high shear mixer or (2B) Silverson high shear mixer and from IKA mixer to (3) homogenizer.

FIG. 4 illustrates an example analytical result of particle size and distribution measurement of Sample 19 according to Example 4.

FIG. 5A illustrates viscosity curves of various beverage samples according to Example 6.

FIG. 5B illustrates viscosity closeness to 100% orange juice of various beverage samples according to Example 6.

### DETAILED DESCRIPTION

### Puree of Palm

The present disclosure generally relates to a food product or a foodstuff or a beverage derived from a palm or a part thereof. In particular, the present food product is related to a puree or a paste or a flowable food or the like comprising particulate of a palm, preferably a heart of palm (or palm heart). In some embodiments, the puree is in a concentrate form, or is dried or substantially dried. The present disclosure also relates to a puree product of palm made by the process described in the present disclosure. The term “puree of palm” used herein encompasses any form of puree of palm or a puree product made by the present process.

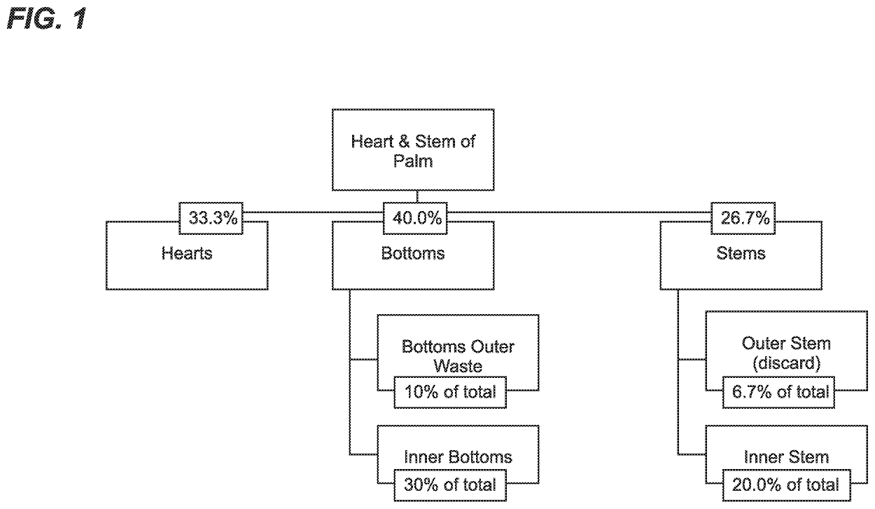

Palm used herein refers to a vegetable harvested from certain species of palm trees native to South and Central America. During harvest, a trunk of a palm tree is cut from the roots and the crown or canopy is removed from the top of the stem. As shown in FIG. 1, a raw and unprocessed palm used to make the present food product herein generally comprises three components, a heart (heart portion), a bottom (bottom portion) attached to the heart, an outer shell surrounding the heart. As used herein, heart refers to heart of palm or palm heart, and is interchangeable with core or inner heart; and outer shell refers to shell of palm or palm shell, and is interchangeable with outer layer, or shell, or sheath, or stem, or stem shell. The heart of palm generally has a substantially cylindrical or roll-like shape.

The palm heart is an edible part of palm and is preferably used to make the present food product. The heart of palm may be from a raw and unprocessed palm that is harvested or from a commercial source such as canned or jarred heart of palm that is generally available in food market. The bottom of the palm (bottom attached to the palm heart) is less edible than the palm heart, with denser and more fibrous structure. However, bottoms of palm can be a rich source of dietary fiber and can be used as a functional component for other beverage or food products. When selecting the palm for the present puree of palm, the bottom may not be separated off from the palm heart. Alternatively, the bottom may be removed from the palm heart. The weight ratio of heart to bottom may be adjustable to a desirable level. The stem shell is significantly more difficult to process than the heart or the bottom due to its bulbous shape and its denser, more fibrous structure. Additionally, the shell typically has a less pleasant odor than the heart. The shell also has a taste that is less preferable than the taste of the heart and the bottom due, at least in part, to these characteristics. Therefore, the shell is typically discarded and not used as a part of palm for the present puree or the food product thereof. Example 2 of the present disclosure further describes the composition and wt % of each component of raw palms.

Heart of palm is significantly low in calorie and advantageously rich in fibers particularly insoluble fibers, and thus provides a vegetable-forward, keto-friendly alternative to traditional high carbohydrate food options for health-conscious consumers in the retail and restaurant channels.

Accordingly, the present puree may comprise a palm heart, or a palm bottom, or both, and the weight ratio of the heart to the bottom is adjustable. Alternatively, the present puree may be free or substantially free from palm bottom. In preferred embodiments, the present puree is free or substantially free from palm shell.

Puree used herein refers to a smooth and creamy food substance that has been ground, pressed, blended or sieved to the consistency of a paste or liquid food or wet food. Puree is often characterized as a particulate material having an average particle size. The particle size is related to the viscosity, mouthfeel, texture, and other sensory aspects of the puree. In some embodiments, the present puree of palm has an average particle size of about 1,000 micron or less, or about 900 micron or less, or about 800 micron or less, or about 700 micron or less, or about 600 micron or less, or about 500 micron or less, or about 400 micron or less, or about 300 micron or less, or about 200 micron or less, or about 100 micron or less, or about 75 micron or less, or about 50 micron or less, or about 250 micron or less, or about 10 micron or less. In some embodiments, the present puree of palm has an average particle size from about 50 micron to about 1,000 micron, or from about 75 micron to about 800 micron, or from about 100 micron to about 700 micron, or from about 200 micron to about 600 micron, or from about 300 micron to about 500 micron. The present puree may have various size distribution modal such as a monomodal distribution, or a bimodal distribution, or a trimodal distribution.

In some embodiments, the present puree has a viscosity of about 5,000 centipoises or less, or about 4,000 centipoises or less, or about 3,000 centipoises, or about 2,000 centipoises or less, or about 1,900 centipoises or less, or about 1,800 centipoises or less, or about 1,700 centipoises or less, or about 1,600 centipoises or less, or about 1,500 centipoises or less, or about 1,400 centipoises or less, or about 1,300 centipoises or less, or about 1,200 centipoises or less, or about 1,100 centipoises or less, or about 1,000 centipoises or less, or about 900 centipoises or less, or about 800 centipoises or less, or about 700 centipoises or less, or about 600 centipoises or less, or about 500 centipoises or less, or about 400 centipoises or less, or about 300 centipoises or less. In some embodiments, the present puree has a viscosity from about 100 centipoises to about 5,000 centipoises, or from about 300 centipoises to about 4,000 centipoises, or from about 600 centipoises to about 3,000 centipoises, or from about 900 centipoises to about 2,000 centipoises, or from about 1,500 centipoises to about 2,500 centipoises. In certain embodiments, the present puree may have a viscosity that is close to traditional banana puree and therefore resemble the flow characteristic of the banana puree.

In some embodiments, the present puree comprises an acid or acids. The acid(s) may be any of organic acids and inorganic acids, but organic acids are preferred. Examples of organic acids include citric acid, acetic acid, succinic acid, malic acid and ascorbic acid. In view of flavor and taste, citric acid is preferred. Examples of inorganic acids include phosphoric acid.

Acids that can be used further include juices of fruits containing an acid or acids such as citric acid. Examples of such fruits are citrus fruits, oranges, lemons, grapefruits, pomelos, lime, lemon, acerola, kiwi, lime, yuzu (Citrus junos Tanaka), kabosu (Citrus sphaerocarpa Tanaka), and sudachi (Citrus sudachi). Particularly preferred are lemon and lime. The fruit juice may be used as it is, or 100% whole juice, or diluted juice, or in the form of a concentrate, or in the form of a not from concentrate (NFC). Fruit juice may also provide fruit flavor and other useful and beneficial ingredients for the puree of palm.

The acid(s) may be used in any effective amount to arrive at a desired pH and/or other desired effects of the present puree. In embodiments, the acid is a citric acid from about 0.01 wt % to about 10 wt %, or from about 0.1 wt % to about 5 wt %, from about 0.5 wt % to about 3 wt %, based on the total weight of the puree of palm obtained. Acid may be a helpful ingredient and/or a viscosity modifier to regulate the color, texture, flowability, and taste profile, and stability of the puree. In some embodiments, the present puree has a pH from about 2 to about 8, or from about 3 to about 7, or from about 4 to about 6, or from about 4 to about 5. The puree of palm without acidification typically has a pH of 6 or higher. The puree treated with acids typically has a lower pH relative to the untreated puree, preferably in a range from about 3 to about 6, or from about 3 to about 5, or from about 3 to about 4.

In some embodiments, the present puree of palm has a Brix value of about 25° or less, or about 24° or less, or about 23° or less, or about 22° or less, or about 21° or less, or about 20° or less, or about 19° or less, or about 18° or less, or about 17° or less, or about 16° or less, or about 15° or less, or about 14° or less, or about 13° or less, or about 12° or less, or about 11° or less, or about 10° or less, or about 9° or less, or about 8° or less, or about 7° or less, or about 6° or less, or about 5° or less, or about 3° or less. In some embodiments, the present puree has a Brix value from about 3° to about 25°, or from about 3° to about 23°, or from about 3° to about 20°, or from about 3° to about 18°, or from about 3° to about 16°, or from about 3° to about 13°, or from about 3° to about 11°, or from about 4° to about 9°, or from about 4° to about 7°, or from about 5° to about 7°. Typically, the freshly made puree of palm has a Brix value in a range from about 3° to about 11°. A puree concentrate of palm can be made upon concentration or removal of water from the freshly made puree of palm. Such puree concentrate may accordingly have a higher Brix value, in a range from about 10° to about 25°.

In some embodiments, the present puree has a total carbohydrates of about 30 g/100 g or less, or about 29 g/100 g or less, or about 28 g/100 g or less, or about 27 g/100 g or less, or about 26 g/100 g or less, or about 25 g/100 g or less, or about 24 g/100 g or less, or about 23 g/100 g or less, or about 22 g/100 g or less, or about 22 g/100 g or less, or about 21 g/100 g or less, or about 20 g/100 g or less, or about 19 g/100 g or less, or about 18 g/100 g or less, or about 17 g/100 g or less, or about 16 g/100 g or less, or about 15 g/100 g or less, or about 14 g/100 g or less, or about 13 g/100 g or less, or about 12 g/100 g or less, or about 11 g/100 g or less, or about 10 g/100 g or less, or about 9 g/100 g or less, or about 8 g/100 g or less, or about 7 g/100 g or less, or about 6 g/100 g or less, or about 5 g/100 g or less, or about 4 g/100 g or less, or about 3 g/100 g or less, or about 2 g/100 g or less. In some embodiments, the present puree has a total carbohydrates from about 2 g/100 g to about 20 g/100 g, or from about 3 g/100 g to about 18 g/100 g, or from about 4 g/100 g to about 16 g/100 g, or from about 5 g/100 g to about 14 g/100 g, or from about 5 g/100 g to about 10 g/100 g, or from about 5 g/100 g to about 8 g/100 g, or from about 5 g/100 g to about 6 g/100 g. The carbohydrates include but are not limited to fructose, glucose, sucrose, lactose, maltose, galactose, or other natural sugars derived from palm. In preferred embodiments, the present puree is free or substantially free from a sweetener including artificial sweetener, natural sweetener, low calorie sweeteners made synthetically or by bioengineering processes.

In some embodiments, the present puree has a total fiber content from about 0.1 g/100 g to about 20 g/100 g, or from about 0.3 g/100 g to about 15 g/100 g, or from about 0.5 g/100 g to about 10 g/100 g, or from about 1 g/100 g to about 5 g/100 g, or from about 1.5 g/100 g to about 3 g/100 g, or from about 2 g/100 g to about 2.5 g/100 g. The dietary fiber may comprise insoluble fiber and soluble fiber, such as cellulose, a-glucan, pectin. In certain embodiments, the dietary fiber consists essentially of insoluble fiber.

In some embodiments, the present puree has a solid content from about 1 wt % to about 90 wt %, or from about 2 wt % to about 95 wt %, or from about 3 wt % to about 90 wt %, or from about 4 wt % to about 80 wt %, or from about 5 wt % to about 70 wt %, or from about 6 wt % to about 60 wt %, or from about 7 wt % to about 50 wt %, or from about 8 wt % to about 40 wt %, or from about 9 wt % to about 30 wt %, or from about 10 wt % to about 20 wt %.

Typically, the freshly-made puree has a solid content from about 1 wt % to about 50 wt %, or from about 2 wt % to about 40 wt %, or from about 3 wt % to about 30 wt %, or from about 4 wt % to about 20 wt %, or from about 5 wt % to about 15 wt %, or from about 6 wt % to about 10 wt %. The puree concentrate of palm or dried puree of palm may have a higher solid content than the freshly-made puree.

In some embodiments, the present puree of palm heart may advantageously have a reduced vegetable flavor compared with raw or unprocessed palm heart. The vegetable notes or volatiles could be removed or reduced during the processing of making the puree.

In some embodiments, the present puree of palm comprises an a functional ingredient selected from the group consisting of an electrolyte, a vitamin, a mineral, a metal ion, a probiotic, a prebiotic, a symbiotic, a phytonutrient, an amino acid, a protein, an antioxidant, a fatty acids, or combinations thereof.

In some embodiments, the present puree comprises ascorbic acid (Vitamin C). It was surprisingly found that the ascorbic acid could effectively stabilize the puree, improve the freshness thereof, and more importantly, enable the puree to maintain in a white/creamy appearance and resist oxidation, yellowing, or unfavorable change in color.

In some aspects, the present disclosure relates to a food product consisting essentially of the puree of palm described herein. The food product may be served as is to the food market without adding other ingredient or substance. As an exemplary example, the puree of palm heart may be used as a low-calorie substitute for traditional banana puree, which is significantly higher in total carbohydrates.

In other aspects, the present disclosure relates to a food product comprising the puree of palm as an ingredient or component. The food product encompasses any form of food including but not limited to a foodstuff, a beverage, a juice, a snack food, a baked product, a pasta, a squeezable wet food, a spoonable wet food, a dip, a whip, a sauce, a salad dressing, a shelf stable multi-textured snack or mini-meals, and combinations thereof. The baked product comprising the present puree may include wafer(s), cracker(s), cookie(s), cake(s), bread(s), muffin(s), extruded snack(s), cookies, and biscuit(s).

The present puree, or puree concentrate, or dried puree may be advantageously employed as a functional food ingredient, wherein the function is for example and without limitation, a vegan whip base, a natural gelating agent, a fiber fortifying ingredient, a texture modifier, a viscosity enhancer, a dispersing agent, an emulsifying agent, a natural binder, and combinations thereof.

As an exemplary embodiment, a beverage comprises a NFC whole orange juice and a puree of palm described herein. The orange juice may be diluted or filtered and have a reduced sugar content or calorie and a reduced viscosity relative to the NFC orange juice. The puree of palm added to the orange juice may effectively restore the viscosity and texture of the beverage so as to resemble the whole juice with respect to taste, mouthfeel, and sensory property, without increasing the sugar content or calorie.

### Process of Making

In some aspects, the present disclosure relates to a process for making a puree of palm described herein. In some embodiments, a process comprises providing a palm or a part thereof; and subjecting the palm or the part thereof to a particle size reduction process, thereby forming the puree thereof. In embodiments, the present process further comprises a homogenizing the formed puree.

As described above, a palm typically comprises a heart, a bottom, and a shell. The heart is more edible and of less vegetable flavor and is thus preferred for making the puree. In some embodiment, the present process comprises providing a harvested palm comprising a heart and a bottom attached to the heart and a shell surrounding the heart; removing the shell from the heart; and chopping the heart into pieces in about 0.5 inch to about 3 inches, prior to the size reduction process. The chopped palm heart and the bottom could be combined and subjected to the size reduction process.

Alternatively, the palm heart and the palm bottom may be further separated by cutting the bottom off the heart. The palm heart and palm bottom may be separately subjected to the size reduction process. In some embodiments, both the bottom and the shell are discarded.

The size reduction step may comprise a mechanical size reduction step. The mechanical size reduction step may include any technique common in the art of food preparation, such as but not limited to grinding, knife grinding, plate grinding, milling, coarse milling, fine milling, colloidal milling, shearing, threshing, blending, or combinations thereof. The mechanical size reduction step may be carried out by standard food production facilities or equipment, or by common kitchen appliances such as blender or mixer. A person skilled in the art will appreciate the principles and operational parameters of the size reduction machinery in order to achieve puree of palm described in the present disclosure.

Preferably, the present process comprises a heat treatment of the palm heart. It was discovered that when raw palm hearts were heat-treated through processes such as blanching in boiling water, a hot water shower, a steam shower, steam-parching, microwave heating, oven-baking, or frying, many advantages are created. For instance, the blanching of raw palm hearts with boiling water for about 2 min or more changes a plurality of properties of green banana: 1) to soften the palm hearts; 2) to soften the palm hearts enough to be processed using conventional pureeing and pasteurizing systems without employing high feeding pump pressure; 3) to reduce the initial load of microorganisms present on the palm hearts; 4) to allow the fiber to be pre-swelled in favor of the size reduction step; 6) to inactivate unfavorable browning reactions in the palm hearts and to reduce astringency taste therein; and 7) to remove or reduce the vegetable notes or volatiles from the palm hearts.

In some embodiments, the present process comprises treating the palm or the part thereof with boiling water for at least about 3 min, or at least about 5 min, or at least about 10 min, or at least about 15 min, or at least 20 min, or at least about 30 min. It was surprisingly found that the boiling process could effectively flush off unfavorable vegetable notes or volatile from the palm thereby eliminating or reducing vegetable flavor or taste in the puree or any food product derived therefrom.

In some embodiments, the present process comprises an ultra-high temperature (UHT) processing or a vacuum cooling step to facilitate evaporation of vegetable flavor or volatile from the formed puree.

In some embodiments, the present process further comprises treating the palm with an effective amount of an acid described herein. The acid may be pre-dissolved in water forming an aqueous solution of acid. In some embodiments, the present process further comprises adding a fruit juice into the palm. The acid and/or the fruit juice can be mixed with the chopped palm pieces, prior to the size reduction process. Alternatively, the acid and/or fruit juice can be added to the palm during the size reduction process or the homogenization process. The acid and/or fruit juice can be added continuously or all at once.

In some embodiments, the present process further comprises treating the heart of palm with an effective amount of an enzyme preparation. The enzyme treatment could effectively reduce the fiber content, regulate the viscosity and texture of the puree, thereby improving the appearance, mouthfeel, or other sensory properties of the puree of palm.

The enzyme preparation used herein may comprise a hemicellulase. Hemicellulases as used herein are enzymes capable to break down hemicellulose like lignocellulose. Any hemicellulase suitable for use in hydrolyzing hemicellulose, preferably into xylose, may be used. Preferred hemicellulases include acetylxylan esterases, endo-arabinases, exo-arabinases, arabinofuranosidases, feruloyl esterase, endo-galactanases, exo-galactanases, glucuronidases, mannanases, xylanases, and mixtures of two or more thereof. Preferably, the hemicellulase for use in the present invention is an exo- and endo-acting hemicellulase, and more preferably, the hemicellulase is an exo-acting hemicellulase which has the ability to hydrolyze hemicellulose under acidic conditions of below pH 7, preferably pH 3-7. A hemicellulase such as xylanase may be obtained from any suitable source, including fungal and bacterial organisms, such as Aspergillus, Disporotrichum, Penicillium, Neurospora, Fusarium, Trichoderma, Humicola, Thermomyces, Myceliophtora, Crysosporium, and Bacillus. In one aspect, the hemicellulase(s) may comprise a commercial hemicellulolytic enzyme preparation. Examples of commercial hemicellulolytic enzyme preparations suitable for use in the present invention include, for example, BIOFEED WHEAT®, BIO-FEED Plus®L, CELLIC® HTec, CELLIC® HTec2, VISCOZYME®, ULTRAFLO®, PENTOPAN MONO®BG, SHEARZYME®, and PULPZYME®HC (from Novozymes A/S), ACCELLERASE® XY, ACCELLERASE® XC, LAMINEX®, and SPEZYME®CP (from Genencor Int.), ECOPULP® TX-200A (from AB Enzymes GmbH), BAKEZYME® HSP 6000 (from DSM Food Specialties), Depol™ 333P, Depol™ 740L, and Depol™762P (from Biocatalysts Ltd), or the like.

The enzyme preparation used herein may comprise a pectinase. Pectinases as used herein are enzymes capable to break down polysaccharide such as pectin. Commonly referred to as pectic enzymes, pectinases also include pectolyase, pectozyme, polygalacturonase, polymethylgalacturonase, or pectin depolymerase. A pectinase could hydrolyze the α(1-4) linkage of pectinic acid, pectin, pectic acid, and the like. Moreover, in the present disclosure, the pectinases also include pectin methyl esterase which hydrolyzes the methyl ester of the carboxyl group of galacturonic acid. The pectinase used in the present disclosure may be any pectinase, in particular of microbial origin, in particular of bacterial origin, such as a pectinase derived from a species within the genera Bacillus, Clostridium, Pseudomonas, Xanthomonas and Erwinia, or of fungal origin, such as a pectinase derived from a species within the genera T. choderma or Aspergillus, in particular from a strain within the species Aspergillus niger and Pispergillus aculeatus. Contemplated commercially available pectinases include PECTINEX® Ultra-SPL, PECTINEX® Ultra Tropical or PECTINEX® Ultra Color (from Novozymes), ROHAPECT® Classic, ROHAPECT® 10L (from AB Enzymes GmbH). Additional examples of pectolytic enzyme preparation include Pectinex™ Ultra Tropical, Pectinex™ Ultra SP-L, Pectinex™ BE, Fla-Vourzyme™, Kojizyme™, Shearzyme™, Pectinex™ AFP L-2, Pectinex™ SMASH, Novozyme 188, Rheozyme®, Pectinex AR, Crystalzyme PML-MX, Biopectinase Super 7X, and EZ9100, Sucrase (from Sankyo Co., Ltd.), Meicelase (from Meiji Seika Kaisha, Ltd.), Pectinase G “Amano,” Pectinase PL “Amano,” Newlase F (from Amano Enzyme Inc.), Sumizyme MC (from Shin-Nihon Chemical Co., Ltd.), or the like.

The enzyme preparation may comprise both a hemicellulase and a pectinase. As an exemplary example, the enzyme preparation comprises a preparation of Viscozyme L and a preparation of Pectinex® Ultra Tropical. Enzyme treatment may proceed at an elevated temperature, for example, at about 40° C. to about 70° C. for about 30 min to about 5 hour.

The enzyme preparation used herein may also include other enzymes including but not limited to α-amylase, agarase, achromopeptidase, ascorbic acid oxidase, aminopeptidase, β-amylase, amylase G4, ant shea kinase, isomaltodextranase, actinidin, α-acetolactate decarboxylase, alginate lyase, isoamylases, inulinase, invertase, urease, exo-maltotetrahydrolase oh hydrolase, esterase, elastase, end maltohexaose oh hydrolase, end maltopentaose oh hydrolase, catalase, α-galactosidase, β-galactosidase, carboxypeptidase, xylanase, chitinase, chitosanase, glucanase, glucoamylase, glucosidase α-, β-glucosidase, α-glucosyltransferase, glucose isomerase, glucose oxidase, transglutaminase, protein glutaminase such as, acid phosphatase, cyclodextrin glucanotransferase, superoxide dismutase, cellulase, tannase, 5′-deaminase, dextranase, transglucosidase, transglutaminase, triacylglycerol lipase, trypsin, trehalose phosphorylase, narinjinaze, nitrilase, neuraminidase, peroxidase, papain, pancreatin, ficin (phytic: ficin), fructosyltransferase, pullulanase, protease, bromelain, hesperidinase, pepsin, peptidase, hemicellulase, phosphodiesterase, phospholipase, polyphenol oxidase, maltose phosphorylase, maltotriosyl hydrolase, muramidase, lactoperoxidase, lysozyme, lipase, lipoxygenase, phytase, cellulase, glucanase, protease, beta-1,3 glucanase, and xylanase, and the like.

The enzyme preparation may be added to the palm prior to the size reduction process, or during/after the size reduction process, or during/after the homogenization process.

In some embodiments, the present process further comprises adding an ascorbic acid (water-soluble Vitamin C) to the palm or puree of palm. The ascorbic acid may be pre-dissolved in water as an aqueous solution. The ascorbic acid may be added prior, or during, or after the size reduction step and/or the homogenization step.

In some embodiments, the present process further comprises concentrating the formed puree, thereby forming a puree concentrate thereof. Concentration can be achieved by heating or drying the puree to reduce the moisture or water content thereof. The puree concentrate of palm may have a higher Brix value compared with unconcentrated puree, in a range from about 5° to about 30°, or from about 10° to about 25°, or from about 15° to about 20°.

In some embodiments, the present process further comprises subjecting the palm to a juicing process, thereby forming a juice fraction and a pulp fraction; and subjecting the pulp fraction to the size reduction process, forming a palm pulp puree. In embodiments, the process further comprises drying the pulp puree to yield a dried mass of palm particulate.

In some embodiments, the present process comprises converting the puree of the puree concentrate into dried mass, or in a form of powder or flake. Palm heart powder and flake processing comprises dehydration of the puree of palm by commercial dehydrators or dryers including for example and without limitation dram dryers, hot-air tunnel oven dryers, infra-red dryers, microwave dryers, reflectance window dryers, or a combination of dryers. Typically, palm powder or flakes are dried to achieve a moisture content of below about 10 wt %, or about 9 wt %, or about 8 wt %, or about 7%, or about 6 wt %, or about 5 wt %, or about 4 wt %, or about 3 wt %, or about 2 wt %, or about 1 wt %. After drying processes, the dried palm powder or flakes may be ground or sieved, based on the final application specifications.

In some embodiments, the present process may comprise an optional food preservation step. This food preservation step may include any technique common in the art of food preparation, such as but not limited to pasteurization, thermization, sterilization, UHT, including retort sterilization, high pressure processing (HPP), canning and other methods. This optional step is advantageous as it allows for product with a longer shelf life.

The present process may further comprises pasteurizing the puree of palm product, cooling, freezing, storing, packaging, and shipping the product, all of which are technically common in the art.

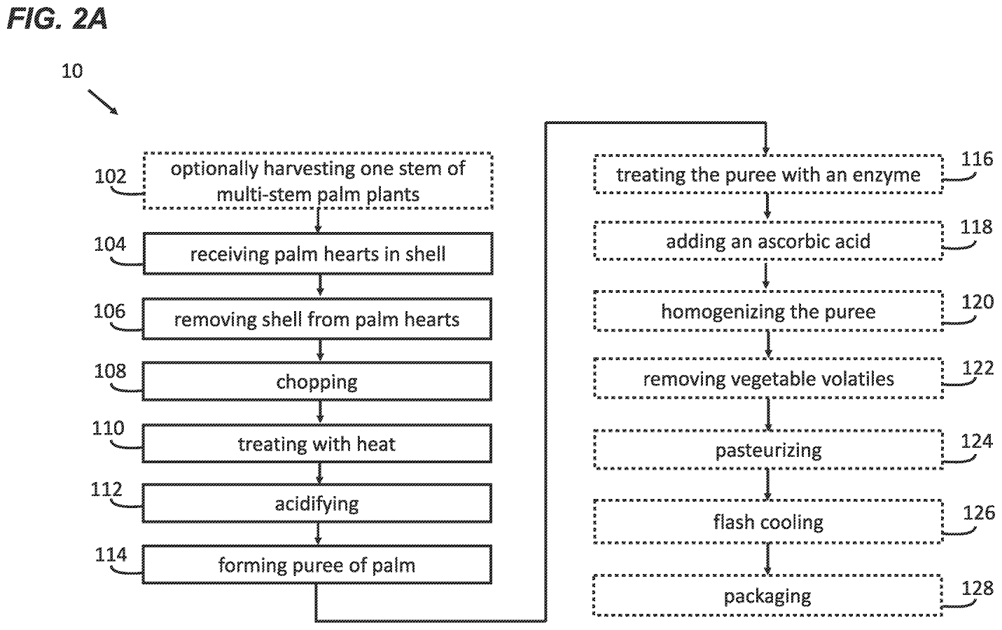

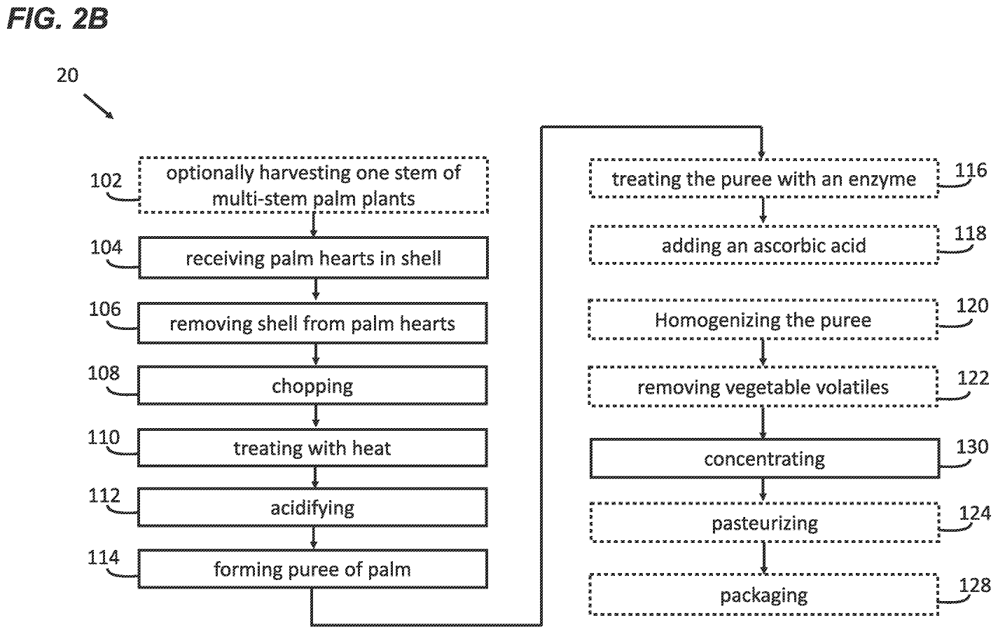

Now referring to FIGS. 2A-2B, particular example processes for making a puree of palm or a puree concentrate according to the present disclosure will be illustrated and described. FIG. 2A illustrates a flow chart of an example process 10 for making a puree of palm. In the illustrated example, the process 10 includes operations 104, 106, 108, 110, 112, and 114. Operation 104 includes receiving palm hearts in shell. In some embodiments, the process 10 optionally includes an operation 102. Operation 102 includes harvesting one stem of multi-stem palm plants to provide palm hearts in shell for the operation 104.

Operation 106 includes removing shell from the palm hearts. In some embodiments, operation 106 further includes removing the palm bottom from the palm. In other embodiments, the bottom is not removed from the palm. The palm heart generated from operation 106 is subjected to further steps for making puree or concentrate.

Operation 108 includes chopping the palm hearts into pieces in about 0.5 inch to about 3 inches. In some embodiments, operation 108 further includes separating the palm bottom off from the chopped palm hearts. In other embodiments, the chopped palm heart and the bottom are combined at 108 for the subsequent steps. In other embodiments, the palm heart and palm bottom may be separately subjected to the subsequent steps.

Operation 110 includes a heat treatment of the palm hearts or palm bottom or the combination generated at 108. In some embodiments, the present process comprises treating the palm or the part thereof with boiling water.

Operation 112 includes an acid treatment. At 112, the palm hearts are treated with an effective amount of an acid or a fruit juice described herein. Operation 112 may be performed before, during, or after operation 114. In some embodiments, the palm hearts are treated with an acid solution having a pH about 4.1 or less at 112. In certain embodiments, the acid solution used in 112 includes a NFC lemon juice, or citric acid, or both.

Operation 114 includes forming puree of palm. At 114, at least one size reduction step described herein is performed to make the puree of palm with the a desired particle size.

In some embodiments, the process 10 further includes one or more of the following optional operations: 116, 118, 120, 122, 124, 126, and 128. Operation 116 includes an enzyme treatment described herein. In some embodiments, the palm hearts are treated with an effective amount of an enzyme preparation comprising an enzyme selected from a hemicellulose, a pectinase, or both. In some embodiments, the enzyme preparation includes additional enzymes described herein. Operation 116 may be performed before, during, or after operation 114.

Operation 118 includes adding an ascorbic acid or a source of ascorbic acid to the puree of palm. The ascorbic acid may be pre-dissolved in water as an aqueous solution before adding to the puree of palm. Operation 118 may be performed before, during, or after the operation 114.

Operation 120 includes homogenizing the puree of palm as described herein. Operation 122 includes removing/evaporating off vegetable volatiles from the puree. Operation 122 may include an ultra-high temperature (UHT) treatment of the puree, or a vacuum cooling treatment of the puree, or both. Operation 124 includes a preservation treatment of the puree. In some embodiments, the formed puree of palm is pasteurized at 124. Operation 126 includes a flash or rapid cooling step to improve the quality of the puree. Operation 128 includes packaging the puree or generating final products, including but not limited to aseptic filling, tote/tank filling, and freezing the packaged puree products. In some embodiments, a NFC puree of palm is produced by process 10, wherein the NFC puree of palm has a Brix value in a range from about 2° to about 10°, or from about 3° to about 8°, or from about 4° to about 6°.

FIG. 2B illustrates a flow chart of an example process 20 for making a concentrate of palm. In the illustrated example, the process 20 includes operations 104, 106, 108, 110, 112, 114, and 130. In some embodiments, the process 20 further includes one or more of the following optional operations 102, 116, 118, 120, 122, 124, and 128. Various aspects of the operations included in the process 20 except operation 130 are described above and will not be repeated here. Operation 130 includes concentrating the formed puree of palm. Concentration at 130 can be achieved by heating or drying the puree to reduce the moisture or water content thereof. In some embodiments, the puree concentrate of palm generated by the process 20 has a Brix value in a range from about 5° to about 30°, or from about 10° to about 25°, or from about 15° to about 20°.

The present disclosure also relates to a puree product of palm made by any process described in the present disclosure.

### EXAMPLES

Certain embodiments of the present disclosure are further described with reference to the following experiments and examples. These experiments, examples, and samples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

### Materials and Methods

Raw palm materials received from a supplier in Costa Rica were separated into fractions (i.e., stem, heart, bottom) according to the present disclosure, and each fraction was used for various experiments. Canned hearts of palm obtained from commercial sources were drained, rinsed with water, and used to test various treatments when fresh hearts were not available. Various reagents in food grade was used in formulations and experiments. Table 1 below summarizes the materials and equipment used in the experiments and examples.

Experiments were conducted on a lab scale in a laboratory or on a pilot scale in a pilot plant with the palm fractions, assessing various formula and process variables to create puree or dried mass.

The analysis of various samples including puree or dried mass was performed using the following analytical and quantitative equipment. For example, Brix is measured by refractometer; Sugar analysis is done by HPLC-RI; Particle size is measured by a Beckman Coulter LS 12 230 Particle Size Analyzer; Viscosity is measured on an Anton Paar Rheometer at a temperature of about 7.2° C. and a shear rate of about 1 s⁻¹ to about 100 s⁻¹. However, one of ordinary skill in the art would understand that the analysis of the various contents could be performed by other analytical means. The equipment, procedures, and parameters for testing and measurement in the present disclosure are generally known or commercially available to a person with ordinary skill in the art.

TABLE 1
Materials and equipment used in the experiments and examples

| MATERIALS AND EQUIPMENT | ORIGINATION |
|---|---|
| Raw, unprocessed hearts of palm | Obtained from Costa Rica |
| Canned hearts of palm, non-GMO, | Obtained from commercial sources |
| 14 oz cans (ingredients: whole | |
| hearts of palm, water, salt, citric | |
| acid) | |
| Lemon Juice, NFC, 7.2° Brix | Prepared |
| Lime Juice, NFC, fresh squeezed | Prepared |
| Citric acid, 10 wt % solution | Prepared |
| (prepared from anhydrous citric | |
| acid) | |
| Ascorbic acid, 10 wt % solution | Prepared |
| (prepared from anhydrous ascorbic | |
| acid) | |
| Pectinex Ultra Tropical | Obtained from Novozyme |
| Viscozyme L | Obtained from Novozyme |
| Blender | Blendtec Stealth 885 |
| Food processor, lab scale | Robot couple R301 Ultra B |
| | Commercial 3.7-Liter Food |
| | Processor, Stainless Steel |
| | Bowl, 120 V |
| Food processor, pilot scale | Robot Coupe Blixer 30 |
| Screw press juicer | Omega verticle low speed juice, 150 |
| | watt |
| Colloid mill, lab scale, | JIAWANSHUN 1.5 KW |
| High shear mixer | Silveson L5M-A |
| High shear mixer | IKA Dispax-Reactor DR 2000/5, |
| | 3-stage, 10 GPM |
| Pleasant Hill Grain Mill Grinder | Wondermill, 1250 watt |
| Induction heater | Home-built |

### Example 1—Comparison of Processing Methods for Making Puree of Palm Hearts and Stems and Investigation of the Effect of Enzymes Treatment on Reducing Fibrous Texture

Raw palm hearts with both shell and bottom removed were chopped into pieces in approximately 1 inch and were used for preparing Samples 1-5. The shell (or the outer fibrous layer about 3 mm thick) of palm stem was shaved with a knife, and the inner portion of the shell was chopped to pieces in about 3 inches and was used for preparing Sample 6. A small fraction of the chopped palm heart was milled in the Blentec blender to reduce particle size, yielding Sample 1. The remaining fraction of chopped palm hearts was milled in the lab scale Robo Coupe food processor to reduce particle size, yielding milled puree samples. This mass was divided into 4 equal parts for the treatments and preparation of Samples 2-5, according to the conditions described in Table 2. Acid treatment was generally performed by adding about 10 wt % of NFC lemon juice to the milled sample, based on the total weight of the sample. The pH was measured before and after acidification as a comparison. The enzyme treatment was generally performed by adding commercial enzyme preparations Viscozyme L and Pectinex Ultra Tropical to the milled sample, each of about 250 ppm, mixing well, and heating the resulted mixture in a water bath for about 90 minutes at about 50° C.

TABLE 2
Samples and treatments thereof according to EXAMPLE 1

| | | Method of | | | | | | | | | |
|---|---|---|---|---|---|---|---|---|---|---|---|
| | | particle size | | | | | | | | | |
| | | reduction | | Acid | | | | | | | |
| | Part | (milling) | | treatment | | | pH prior | pH after | | | |
| Example | of | | Robot | (acidifi- | Enzyme | Brix | treatment | treatment | | | |
| 1 | Palm | Blendtec | Coupe | cation) | treatment | (°) | to acid | acid | Taste | Mouthfeel | Appearance |
| Sample 1 | Heart | Yes | No | No | No | 6.70 | 6.56 | 6.56 | Vegetable | Fibrous, | Yellow, very |
| | | | | | | | | | flavor | non- | lumpy (not |
| | | | | | | | | | | uniform | effective |
| | | | | | | | | | | | at milling) |
| Sample 2 | Heart | No | Yes | No | No | 6.71 | 6.56 | 6.56 | Vegetable | Finer, | Yellow, lumpy, |
| | | | | | | | | | flavor | fibrous | but uniform |
| Sample 3 | Heart | No | Yes | Yes | No | 6.71 | 6.56 | 4.46 | Vegetable | Finer, | Creamy white, |
| | | | | | | | | | flavor | fibrous | uniform lumpy |
| Sample 4 | Heart | No | Yes | Yes | Yes | 6.71 | 6.56 | 4.46 | Vegetable | Almost no | Creamy white, |
| | | | | | | | | | flavor | fiber | uniform lumpy |
| | | | | | | | | | | mouthfeel, | |
| | | | | | | | | | | high | |
| | | | | | | | | | | liquidity. | |
| Sample 5 | Heart | No | Yes | No | Yes | 6.71 | 6.56 | 4.46 | Vegetable | Almost no | Yellow, |
| | | | | | | | | | flavor; | fiber | uniform lumpy |
| | | | | | | | | | slightly | mouthfeel, | |
| | | | | | | | | | bitter | very thin. | |
| Sample 6 | Stem | No | Yes | Yes | Yes | N/A | N/A | N/A | N/A | N/A | Watery |
| | shell | | | | | | | | | | looking, |
| | | | | | | | | | | | straw-like |
| | | | | | | | | | | | strands, very |
| | | | | | | | | | | | fibrous |

The testing results and sensory assessment including Brix value, pH before and after acidification, taste, mouthfeel, and appearance are summarized in Table 2. It was found that the Robot Coupe lab scale blender was highly effective at uniformly reducing particle size of the palm hearts to a lumpy puree mass and the palm shells (inner portion of the or outer layer stems) to a fibrous, straw-like mass (Sample 6). Comparatively, Sample 1 made by using Blendtec blend was non-uniform, indicating that Blendtec blender was not as efficient as Robot Coupe in uniformly reducing particle size of the palm hearts. Without wishing to be bound by any particular theory, it is believed that the mass was pushed to the edges of the blender away from the blades of the Blendtec blender, resulting in the insufficient blending and milling.

Surprisingly, NFC lemon juice at about 10 wt % based on the total weight of the sample could effectively reduce pH of the milled hearts from 6.56 to 4.46 and significantly change the color of the puree from yellow to cream/white, as demonstrated in Samples 3 and 4. Comparatively, Samples 2 and 5 without acid treatment remained the same pH and yellow appearance.

Enzyme treatment was found to be effective in reducing viscosity of the pureed palm heart viscosity fibrous mouthfeel. As shown in Table 2, both Samples 4 and 5 were treated with a commercial hemicellulolytic enzyme preparation (Viscozyme L) and a commercial pectolytic enzyme preparation (Pectinex Ultra Tropical). The enzyme treated puree Samples 4 and 5 were both found to have almost no fibrous mouthfeel with high liquidity. Sample 4 treated with acid and enzyme treatments was found to have the best taste, mouthfeel, and appearance of all. However, enzyme treatment of Sample 6 made from palm stems only resulted in a watery texture, with no improvement of palatability, further suggesting that shell portion of the palm may not be suitable for a puree product directly for human consumption.

All pureed Samples 1-6 had a notable vegetable flavor similar to artichoke hearts.

### Example 2—Composition of Raw Palm

Raw palm stems were received and thawed. Hearts of palms were extracted by hand; bottoms were cut off; and the shell or the outer fibrous layer (˜3 mm) of stems and bottoms were removed. Each fraction was weighed to determine % of total. As shown in FIG. 1, hearts were about 33.3 wt %, bottoms were about 40.0 wt %, and stem shells were about 26.7 wt %. A bottom of palm contains an outer portion of about 10 wt % and an inner portion of about 30 wt %. The outer portion is usually unusable and discarded, while the inner portion may still be usable. A stem shell contains an outer portion of about 6.7 wt % and an inner portion of about 20.0 wt %, both of which may not be usable.

Juices of palm were made according to the following procedure: Hearts of palm were chopped by hand into pieces of about ½ inch and run through a screw press juicer to separate the juice from the pulp. The pulp fraction was dried in a convection oven at about 150° F. for about 90 minutes, resulting in Sample 1. The juice fraction was acidified with NFC lemon juice (17 wt % based on total weight of the sample) to pH 3.98, resulting in Sample 8. Another fraction of hearts was chopped by hand pieces of about 1 inch, milled on the lab scale food processor for about 4 min or until uniform, acidified with NFC lemon juice (17 wt % based on total weight of the sample) to pH 4.03, and run through the lab scale colloid mill in a single pass, resulting in Sample 9.

Remaining hearts of palm were used to prepare a puree concentrate, using the formula shown in Table 3. The mixture was milled in the lab scale food processor until uniform then run through the lab colloid mill, recirculating for 5 minutes. A double boiler was set up on the induction heater to concentrate the puree. The sample was held at about 76° C. to 82° C. for about 2 hours, yielding a final puree concentrate Sample 10, which was then frozen.

TABLE 3
Formula of Sample 3 according to Example 2.

| Ingredient | Weight % |
|---|---|
| Chopped hearts of palm in about ½ to 1 inch | 80.0 |
| Water, bottled, ambient | 12.0 |
| Citric acid, 10% solution | 8.0 |

A puree of palm bottoms was also prepared by the following procedure. The inner bottoms of palm were chopped by hand into pieces of about 1 inch, acidified with NFC lemon juice (17 wt % based on total weight of the sample), milled on the food processor then run through the colloid mill recycling once, yielding Sample 11, which was collected and frozen.

A milled and dried sample of palm stem shells was made by the following procedure. The outer fibrous layer of the stems (approximately 3 mm thick) was shaved with a knife. The remaining stem material was chopped into pieces of about 1 inch and milled on the lab food processor. Milled stems were pressed through the screw press juicer and the dry fraction was further dried in a convection oven at 170° F. for 90 minutes, stopping intermittently to break up clumps to expose moist fractions. Dried stem material was run through a grain mill to reduce particle size, resulting in Sample 12 in as a dried mass. Brix, pH, and sensory measurements of Samples 7-12 were recorded and summarized in Table 4.

TABLE 4
Test results of Samples 7-12 according to Example 2

| | | | Brix prior to | pH prior | | Brix after | | | | |
|---|---|---|---|---|---|---|---|---|---|---|
| Example | Part of | | acidification | to acidifi- | Acidifi- | acidification | pH after | | | |
| 2 | palm | Process | (°) | cation | cation | (°) | acidification | Taste | Mouthfeel | Appearance |
| Sample 7 | Heart | Pulp | N/A | N/A | No | N/A | N/A | N/A | N/A | Dark |
| | | fraction | | | | | | | | yellow, |
| | | from the | | | | | | | | hard, about |
| | | juiced | | | | | | | | 4 mm |
| | | hearts; | | | | | | | | diameter |
| | | dried | | | | | | | | |
| Sample 8 | Heart | Juice | 6.76 | 5.91 | Yes | N/A | 3.98 | Vegetable | Clean | Yellow with |
| | | fraction | | | | | | flavor, | | some soft |
| | | from the | | | | | | tart | | sedimen- |
| | | juiced | | | | | | | | tation |
| | | hearts | | | | | | | | |
| Sample 9 | Heart | Milled | N/A | N/A | Yes | 6.11 | 4.03 | Vegetable | Finer; | Creamy |
| | | | | | | | | flavor, | some | white; |
| | | | | | | | | tart | chewiness | uniform; |
| | | | | | | | | | | like |
| | | | | | | | | | | thin mashed |
| | | | | | | | | | | potatoes |
| Sample | Heart | Milled; | 5.31 | 3.88 | Yes | 9.95 | N/A | Vegetable | Thick | Creamy |
| 10 | | boiled | | | | | | flavor, | pasty | white; |
| | | | | | | | | tart | | thick; sticky |
| Sample | Bottom | Milled | N/A | N/A | Yes | 5.61 | 3.92 | Vegetable | Slightly | Creamy; |
| 11 | | | | | | | | flavor, | more | slight |
| | | | | | | | | tart | fibrous | yellow; |
| | | | | | | | | | than | thick |
| | | | | | | | | | hearts but | |
| | | | | | | | | | acceptable | |
| Sample | Stem | Juiced, | N/A | N/A | No | N/A | N/A | Bland | Dry, | Light |
| 12 | | pulp | | | | | | | fibrous | colored |
| | shell | fraction | | | | | | | | thin straw, |
| | | dried | | | | | | | | brittle |
| | | and | | | | | | | | |
| | | milled | | | | | | | | |

A yield of 55% juice was obtained by pressing palm hearts and subsequently acidified with 17 wt % of NFC lemon juice to pH of 3.98. The juice fraction (Sample 8) was in a light yellow color with some soft sediment forming over time.

Running palm hearts in a single pass through the lab scale colloid mill after the food processor resulted in a fine texture with some chewiness, as demonstrated by Sample 9. The texture and/or viscosity was similar to thin mashed potatoes. A puree concentrate Sample 10 was successfully prepared from this material, with a Brix value increased from 5.76 to 9.95 over a period of about 2 hours. However, Sample 10 having higher Brix appeared viscous and sticky and likely not pumpable. It was found that concentrating the puree reduced the vegetable flavor but developed a mild cooked flavor. These results suggest that the puree concentrate of palm may be used as an ingredient providing fibrous texture or viscosity enhancement for other foodstuff such as a beverage.

Bottoms of palm were processed similarly to single strength pureed hearts and resulted in a very similar appearance texture and flavor to the hearts as demonstrated by Sample 11. However, the resulting puree was slightly more fibrous in texture and mouthfeel. Therefore, it is preferred to use palm heart substantially free from the bottom to maximize the mouthfeel and sensory profile for direct consumption. However, bottoms may still be used as an adjuster or regulator to arrive at a desired level of fiber content or texture when necessary. It is noted that the outer portion of the bottom is much less useful compared with the inner portion.

Stems or stem shells (both inner and outer portions thereof) were also pressed similarly by a juicer and the pulp fraction was dried in a convention oven. Dry milling of the dried pulp on the grain mill was not successful due to the light, airy texture not allowing the dry mass to feed continuously into the mill, as demonstrated by Sample 12. These results suggest that the stem shell of palm processed by the present equipment may not be suitable for puree food product for direct human consumption.

Table 3 provides a summary of nutritional analysis of several samples from Examples 1 and 2. Compared with Sample 2, Sample 4 puree of heart treated with acid and enzymes appear to have reduced fiber content and increased sugar content. Sample 9 puree of heart treated with acid and milled by colloid milling also showed reduced fiber content with a slight increase in total sugar content. The majority of the fiber in the palm heart and palm bottom is insoluble fiber, most likely cellulose and hemicellulose. Potassium is present at a fairly high level in all fractions that were analyzed. The composition of the bottoms is very similar to the hearts, with slightly higher protein and potassium in the hearts than the bottoms. Based on textural, functional and nutritional results, it is feasible to supplement the hearts of palm puree with some of the bottoms material for potential cost savings by utilizing this waste stream.

Samples 6 and 7, both made from palm stem shells are high in fiber (approximately 3 times compared with corresponding samples made from heart and bottom), of which the majority (98%) is insoluble fiber. Sample 6 treated with enzymes still presents a fiber content of 6.5 g/100 g. These results indicate that wet milling of the palm stem shell was not feasible with the equipment as described herein.

TABLE 5
Nutrient analysis of various puree samples of palm heart and palm stem shells

| | | Sample 2 | Sample 4 | Sample 6 | Sample 11 | Sample 9 | Sample 7 |
|---|---|---|---|---|---|---|---|
| | | Part of palm | | | | | |
| | | Heart | Heart | Stem shell | Bottom | Heart | Stem shell |
| | Treatment | | | | | | |
| | | No acid, | Treated | Treated | Treated | Treated | |
| | | no | with acid | with acid | with acid, | with acid, | Juiced, pulp |
| | Added | enzyme | and enzyme | and enzyme | milled | milled | fraction dried |
| | liquid | None | 10.5 wt % | 10.5 wt % | 17 wt % | 17 wt % | None |
| Analysis | Units | | | | | | |
| Calories | Cal/100 g | 25.0 | 29.5 | 27.6 | 25.4 | 28.3 | N/A |
| Total Fatty | g/100 g | 0.325 | 0.309 | 0.096 | 0.211 | 0.301 | N/A |
| Acids | | | | | | | |
| Total | g/100 g | 5.4 | 5.7 | 12.2 | 5.9 | 5.3 | N/A |
| Carbohydrates | | | | | | | |
| Total Dietary | g/100 g | 2.05 | 0.985 | 6.5 | 1.51 | 1.43 | 77.2 |
| Fiber | | | | | | | |
| Insoluble Fiber | g/100 g | 2.05 | 0.985 | 6.5 | 1.51 | 1.43 | 77.2 |
| Soluble Fiber | g/100 g | <0.75 | <0.75 | <0.75 | <0.75 | <0.75 | 1.49 |
| Total Sugar | g/100 g | 0.9 | 2.5 | N/A | 2.3 | 2.0 | N/A |
| Fructose | g/100 g | 0.5 | 0.9 | N/A | 0.8 | 0.9 | N/A |
| Glucose | g/100 g | 0.4 | 1.2 | N/A | 0.8 | 0.9 | N/A |
| Sucrose | g/100 g | <0.1 | 0.2 | N/A | 0.6 | 0.3 | N/A |
| Lactose | g/100 g | <0.1 | <0.1 | N/A | <0.1 | <0.1 | N/A |
| Maltose | g/100 g | <0.1 | <0.1 | N/A | <0.1 | <0.1 | N/A |
| Galactose | g/100 g | <0.1 | <0.1 | N/A | <0.1 | <0.1 | N/A |
| Protein | g/100 g | 2.19 | 1.93 | 0.99 | 1.52 | 2.56 | N/A |
| Potassium | mg/100 g | 318 | N/A | N/A | 217 | 326 | 856 |
| Sodium | ppm | <24.5 | 15.7 | <19.5 | <24.7 | <24.5 | 48.9 |
| Ash | g/100 g | 0.845 | 0.852 | 0.478 | 0.631 | 0.869 | N/A |
| Moisture | g/100 g | 91.3 | 91.2 | 86.2 | 91.8 | 91.0 | 5.81 |
| Total Solids | g/100 g | 8.74 | N/A | N/A | N/A | N/A | N/A |
| Pyridoxal-5- | Mcg/g | N/A | N/A | N/A | <5.00 | <5.00 | N/A |
| phosphate | | | | | | | |

### Example 3— Effect of Boiling on Texture, Mouthfeel, and Flavor of the Puree of Palm Heart

Palm hearts were chopped to pieces of about 1 inch and divided into three batches for making the following samples. Sample 13 as a control was prepared by acidifying hearts with NFC lime juice of about 17 wt % based on the total weight of the sample; blending and milling in a kitchen blender on med/high until uniform. Sample 14 was prepared by adding palm hearts to boiling water, holding for 15 min, removing the hearts and draining, acidifying with NFC lime juice of about 17 wt % based on the total weight of the sample; blending and milling in a kitchen blender on med/high until uniform. Sample 15 was prepared following the same procedure of Sample 14 except that the palm hearts were boiled in water for 30 min prior to acidification and milling. Each of the prepared puree samples were evaluated “as is.” Orange juice samples containing about 3 wt % of each of the prepared puree Samples were also prepared and evaluated as a comparison. Table 6 summarizes the sensory assessment of various samples prepared according to Examples 2 and 3.

TABLE 6
Summary of sensory assessment of various samples of Examples 2 and 3.

| | Part of | Process | Acid | | | | Sensory at 3 wt % |
|---|---|---|---|---|---|---|---|
| | palm | | treatment | Brix (°) | pH | Sensory “as is” | in orange juice |
| Sample 9 | Heart | Chopped, size | Yes | 6.11 | 4.03 | Vegetable flavor, | More opaque than others, |
| | | reduced by a | | | | tart, some | some vegetable flavor, |
| | | food processer | | | | chewiness | small bits on sides of |
| | | followed by | | | | | glass, pulp like texture |
| | | colloid milling | | | | | |
| Sample 13 | Heart | Chopped, size | Yes | 6.31 2 | 3.1 | Stronger | Some vegetable flavor, |
| | | reduced by a | | | | vegetable | some large bits in |
| | | kitchen blender | | | | flavor, very tart, | mouthfeel |
| | | | | | | chewy bits | |
| Sample 14 | Heart | Boiled for about | Yes | 7.20 | 3.0 | Reduced | Less vegetable flavor and |
| | | 15 min; size | | | | vegetable | more orange flavor, some |
| | | reduced by a | | | | flavor, and | bits in mouthfeel |
| | | kitchen blender | | | | thinner | |
| Sample 15 | Heart | Boiled for about | Yes | 5.79 | 3.2 | Least vegetable | More orange flavor than |
| | | 30 min; size | | | | flavor, thinnest | others |
| | | reduced by a | | | | | |
| | | kitchen blender | | | | | |
| Sample 11 | Bottom | Chopped, size | Yes | 5.61 | 3.92 | Vegetable flavor, | N/A |
| | | reduced by a | | | | tart, more fibrous | |
| | | food processer | | | | than others | |
| | | followed by | | | | | |
| | | colloid milling | | | | | |

As shown in Table 6, boiling the canned hearts of palm for 15 or 30 minutes prior to milling resulted in a lower viscosity and reduced vegetable off flavor. Among all, Sample 15 with the palm heart boiled for 30 mins had the best sensory performance, with significantly less vegetable flavor and much thinner compared with others. The orange juice sample containing 3 wt % of Sample 15 puree of palm heart presents more orange flavor than palm, indicating the feasibility of the puree of palm heart as a feasible component providing nutritional and/or textural value for a beverage product. It is noted that other methods such as steam injection could also be considered to flash off vegetable notes based on these results. However, if viscosity is a desirable functional characteristic, then boiling or steam injection may cause unfavorable reduction of viscosity. Processing under nitrogen may be used to avoid oxidation, which is common for making puree of banana.

### Example 4

Pilot scale trials were conducted to assess various unit operations and settings to reduce particle size of the palm hearts to an acceptable level. Banana puree was used as a comparison. Canned palm hearts were used. Ascorbic acid was added to these canned palm hearts to help prevent oxidation, development of strong vegetable off flavor, and browning. Samples were prepared according to the formula of Table 7.

TABLE 7
Formula used for samples according to Example 4.

| Ingredient | Weight % |
|---|---|
| Canned palm hearts, unchopped | 87.62 |
| Water, bottled, ambient | 4.76 |
| Citric acid, 10% solution | 6.67 |
| Ascorbic acid, 10% solution | 0.95 |

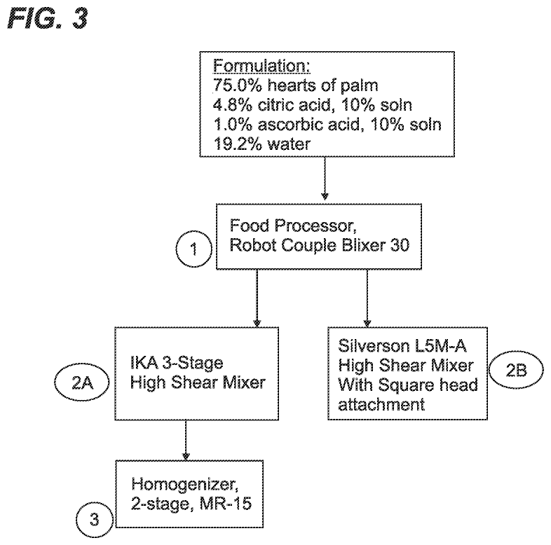

Samples were prepared by the process and equipment shown in FIG. 3. All ingredients were placed in Robot Coupe Blixer 30 and run at low speed for 30 seconds, then high speed for 30 seconds, resulting in Sample 16. A sample was taken for particle size distribution. The mixture was inspected to ensure sufficient smoothness and flowability. The mixture was collected and fed into hopper of IKA high shear mixer. A single pass was made at 30 Hz and sample collected and another at 60 Hz with sample collected. The mass was combined (as Sample 17) and fed into the hopper of the homogenizer MR 15 running at about 1 L/hour and a pressure of about 2500/500 psi. Product was collected following homogenization, yielding Sample 19.

Some of the mass from the Robot Coupe was held for processing on the Silverson high shear mixer. Milled mass was placed in a 600 ml beaker and run on the mixer at the following conditions: 3 minutes at 4,000 rpm followed by 2 minutes at 9,500 rpm, resulting in Sample 18, which was collected for analysis.

All samples were analyzed for particle size distribution in comparison to NFC banana puree.

TABLE 8
Summary of test results for samples according to Example 4

| | | | | Particle size distribution | |
|---|---|---|---|---|---|
| | Process | | Viscosity | Mean | <90% |
| Sample | equipment | Brix (°) | (cPs) | (micron) | (micron) |
| Sample | Robot Coupe | 5.22 | 1913 | 403.3 | 866.4 |
| 16 | Blixer 30 | | | | |
| Sample | Robot Coupe | 5.22 | 1808 | 294 | 622.8 |
| 17 | Blixer 30; | | | | |
| | IKA high | | | | |
| | shear mixer | | | | |
| Sample | Robot Coupe | 5.22 | 1547 | 247.9 | 508.4 |
| 18 | Blixer 30; | | | | |
| | Silverson high | | | | |
| | shear mixer; | | | | |
| Sample | Robot Coupe | 5.22 | 995 | 110.1 | 207.2 |
| 19 | Blixer 30; | | | | |
| | IKA high shear | | | | |
| | mixer; | | | | |
| | homogenizer | | | | |
| | MR 15 | | | | |
| NFC | N/A | 23.4 | 844 | 175.6 | 389.5 |
| Banana | | | | | |
| puree | | | | | |

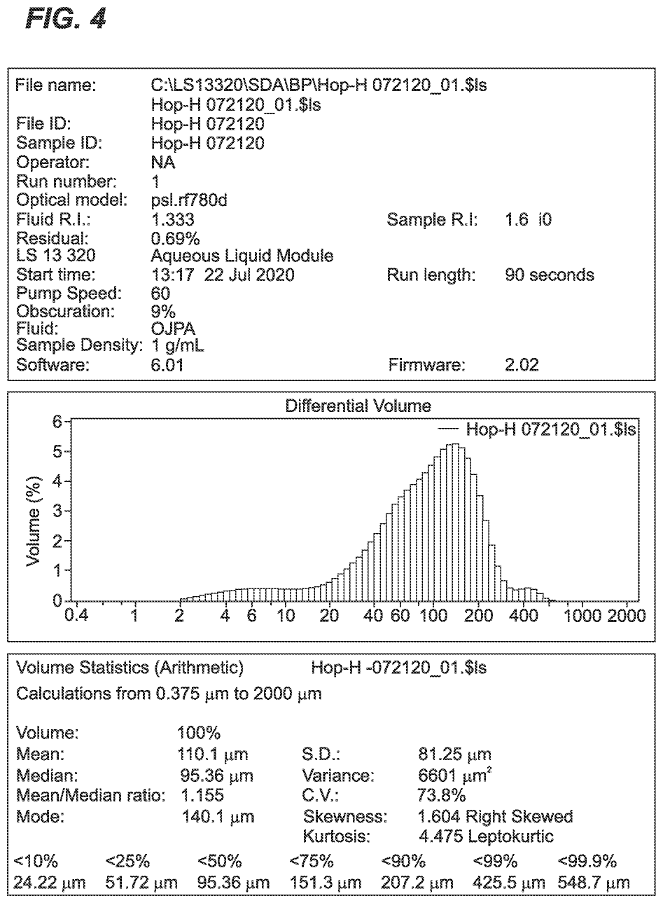

As shown in Table 8 and FIG. 3, both viscosity and average particle size were found to be reduced as the puree ran through the process from one unit to the next. The final viscosity of the homogenized Sample 19 was found slightly higher than banana puree, with a mean size of about 110.1 micron and a near monomodal size distribution as shown in FIG. 4. Surprisingly, all samples 16-19 showed significantly lower calorie, as indicated by a Brix value of about 5.22° and compared with banana puree. These results indicate the feasibility of the present puree of palm heart as a substitute for banana puree where viscosity, mouthfeel, and opacity are needed.

### Example 5

Application of the present puree of palm heart in juice and beverage products are demonstrated herein. Palm stems with hearts were harvested in Costa Rica and dipped into a solution of 1000 ppm ascorbic acid and immediately frozen prior to shipping in an effort to reduce vegetable off flavor that forms from oxidation. Once received in Apopka, FL, stems were thawed. As hearts were extracted they were again dipped in an ascorbic acid solution (1000 ppm) and frozen until use. Thawed hearts were chopped into pieces in about 3 inch, and a small portion of the chopped pieces was prepared to determine the amount of liquid required to reduce viscosity enough to run through the various mixers. The raw hearts produced a more viscous mass than canned hearts. Pilot-scale samples were produced according to the formula of Table 9 in a pilot plant.

TABLE 9
Formula of pilot-scale puree of palm heart according to Example 5

| Ingredient | Weight % |
|---|---|
| Palm hearts, chopped to pieces in about 3 inch | 75.0 |
| Water, bottled, ambient | 19.2 |
| Citric acid, 10% solution | 4.8 |
| Ascorbic acid, 10% solution | 1.0 |

Sample 20 was prepared under following conditions. All ingredients were added to the Robot Coupe Blixer 30 mixer. The batch was run at low speed for 30 seconds then high speed for 30 seconds. The mass was transferred to the hopper of the IKA high shear mixer and run at 60 Hz for 2 passes. Exit temperature of product was about 75° C. The product was not homogenized. Samples were collected in 1-quart pails and frozen.

Flavor of the puree of palm hearts made by pilot process and equipment in Example 5 was clean with very mild vegetable flavor, indicating that use of ascorbic acid was effective at reducing oxidation and resulting vegetable flavor.

### Example 6— Beverages Containing Puree of Palm Heart and Mouthfeel Evaluation

Beverages containing the present puree of palm were prepared and the viscosity and mouthfeel were tested and compared. Orange juice was used as a base for the beverage samples. Beverage Sample 7 and 9 were made by adding about 5.5 wt % of puree of palm heart to a 43 wt % orange juice, based on the total weight of the sample. Comparative samples containing other ingredients without puree of palm were also prepared. All samples were pasteurized at 70° C. for about 10 min and aged for min 2 days before testing. Table 10 summarizes the composition of each beverage sample. The viscosity test was performed on an Anton Paar Rheometer at about 7.2° C., which is a typical juice consuming temperature. The shear rate was set to about 1 s⁻¹ to about 100 s⁻¹, which is a typical range representing drinking experience.

TABLE 10
Formula and selected ingredients of various beverage samples

| | Sample Name |
|---|---|
| Beverage 1 | Orange Juice 100% |
| Beverage 2 | Orange Juice 43% |
| Beverage 3 | Orange Juice 43% + Sugar (final Brix of 11.2°) |
| Beverage 4 | Orange Juice 43% + Homogenized Pulp 1.75% |
| Beverage 5 | Orange Juice 43% + Homogenized Pulp + Pectin 0.069% |
| Beverage 6 | Orange Juice 43% + Homogenized Pulp + Citrusfiber |
| | 0.06% |
| Beverage 7 | Orange Juice 43% + Homogenized Pulp + Hearts of Palm |
| | Puree 5.5% |
| Beverage 8 | Orange Juice 43% + Homogenized Pulp + Pectin 0.069% + |
| | Citrusfiber 0.06% |
| Beverage 9 | Orange Juice 43% + Homogenized Pulp + Pectin 0.069% + |
| | Hearts of Palm Puree 5.5% |

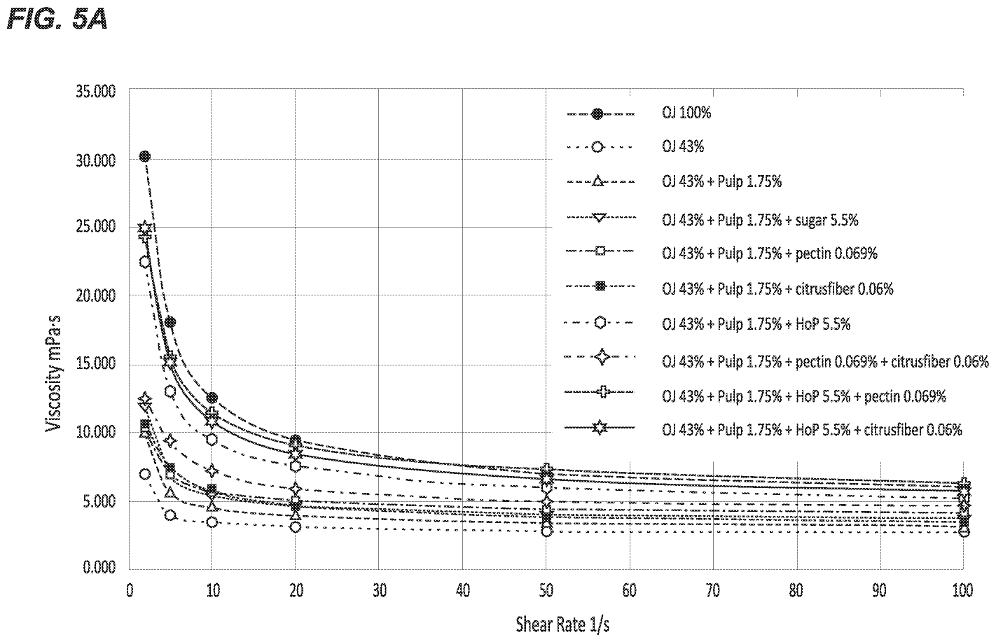

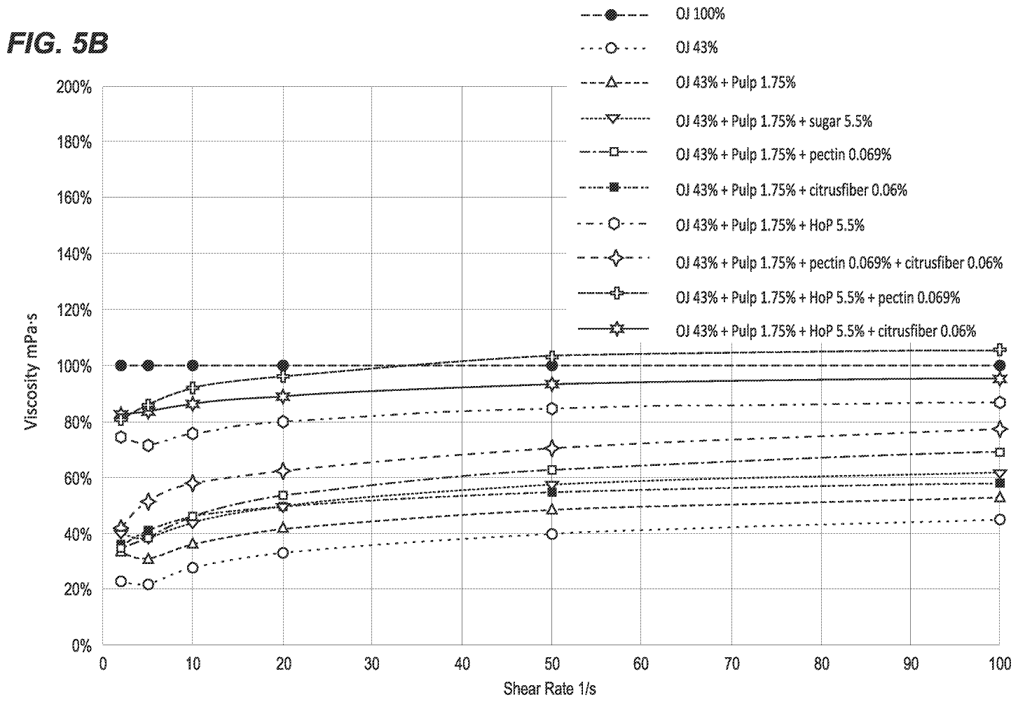

As shown in FIGS. 5A and 5B, Beverage 7 and 9 both have a viscosity curve closest to that of the 100% orange juice (Beverage 1), better than any other beverage samples without the puree of palm hearts. Comparatively, Beverage 2 as the diluted (43 wt %) orange juice has the largest gap in viscosity with the 100% orange juice through the full spectrum. These results indicate the efficiency and effectiveness of puree of palm heart as a viscosity regulator in restoring the viscosity of diluted juice to the level of whole juice and providing a low-calorie juice beverage without significant change to the mouthfeel or taste experience.

### Numbered Clauses

The following numbered clauses define further example aspects and features of the compositions, methods, and techniques of the present disclosure:
1. A foodstuff consisting of a puree of palm.
2. The foodstuff of clause 1, wherein the palm comprises palm heart.
3. The foodstuff of clause 2, wherein the palm heart comprises a major portion and a bottom.
4. The foodstuff of any of clauses 1-2, wherein the palm is substantially free from palm shell or palm stem.
5. The foodstuff of any of clauses 1-4, wherein the puree has an average particle size from about 50 micron to about 1,000 micron, or from about 100 micron to about 800 micron, or from about 200 micron to about 600 micron, or from about 300 micron to about 500 micron.
6. The foodstuff of any of clauses 1-5, wherein the puree has a viscosity from about 100 centipoises to about 5,000 centipoises, or from about 300 centipoises to about 4,000 centipoises, or from about 600 centipoises to about 3,000 centipoises, or from about 900 centipoises to about 2,000 centipoises, or from about 1,500 centipoises to about 2,500 centipoises.
7. The foodstuff of any of clauses 1-6, wherein the puree further comprises an acid selected from the group consisting of citric acid, acetic acid, fumaric acid, lactic acid, phosphoric acid, malic acid, tartaric acid, ascorbic acid, any derivatives thereof, or any combinations thereof.
8. The foodstuff of any of clauses 1-7, wherein the puree has a pH from about 2 to about 8, or from about 3 to about 7, or from about 4 to about 6, or from about 4 to about 5.
9. The foodstuff of any of clauses 1-8, wherein the puree has a Brix value from about 3° to about 10°, or from about 4° to about 9°, or from about 4° to about 7°, or from about 5° to about 7°.
10. The foodstuff of any of clauses 1-9, wherein the puree has a total carbohydrates from about 2 g/100 g to about 20 g/100 g, or from about 3 g/100 g to about 18 g/100 g, or from about 4 g/100 g to about 16 g/100 g, or from about 5 g/100 g to about 14 g/100 g, or from about 5 g/100 g to about 10 g/100 g, or from about 5 g/100 g to about 8 g/100 g, or from about 5 g/100 g to about 6 g/100 g.
11. The foodstuff of any of clauses 1-10, wherein the puree has a total fiber content from about 0.1 g/100 g to about 10 g/100 g, or from about 0.3 g/100 g to about 8 g/100 g, or from about 0.5 g/100 g to about 6 g/100 g, or from about 1 g/100 g to about 4 g/100 g, or from about 1.5 g/100 g to about 3 g/100 g, or from about 2 g/100 g to about 2.5 g/100 g.
12. The foodstuff of any of clauses 1-11, wherein the puree has a solid content from about 1 wt % to about 50 wt %, or from about 2 wt % to about 40 wt %, or from about 3 wt % to about 30 wt %, or from about 4 wt % to about 20 wt %, or from about 5 wt % to about 15 wt %, or from about 6 wt % to about 10 wt %.
13. The foodstuff of any of clauses 1-12, wherein the puree has a reduced vegetable flavor compared with raw palm.
14. A beverage comprising the puree according to any of clauses 1-13.
15. The beverage of clause 14, further comprising a fruit juice, wherein the fruit is selected from the group consisting of citrus fruits, oranges, lemons, grapefruits, pomelos, limes, various true or hybrid cultivars thereof, and any combinations thereof.
16. The beverage of clause 15, wherein the fruit juice is a NFC juice.
17. The beverage of any of clauses 14-16, further comprising an a functional ingredient selected from the group consisting of an electrolyte, a vitamin, a mineral, a metal ion, a probiotic, a prebiotic, a symbiotic, a phytonutrient, an amino acid, a protein, an antioxidant, a fatty acids, or combinations thereof 18. The beverage of any of clauses 14-17, comprising ascorbic acid.
19. A foodstuff comprising the puree according to any of clauses 1-13.
20. The foodstuff of clause 19 being a baked foodstuff selected from the group consisting of wafer(s), cracker(s), cookie(s), cake(s), bread(s), muffin(s), extruded snack(s), and biscuit(s).
21. A process for making a puree of a part of palm, the process comprising:
   providing a heart of palm; and
   subjecting the heart of palm to a particle size reduction process, forming a puree thereof.
22. The process of clause 21, further comprising homogenizing the formed puree.
23. The process of any of clauses 21-22, wherein providing a heart of palm comprises:
   providing a harvested palm comprising a heart and a shell surrounding the heart;
   removing the shell from the heart; and
   chopping the heart into pieces in about 0.5 inch to about 3 inches.
24. The process of clause 23, further comprising:
   removing a bottom from the heart of palm.
25. The process of any of clauses 21-24, further comprising treating the chopped heart of palm with boiling water for at least about 3 min, or at least about 5 min, or at least about 10 min, or at least about 15 min, or at least 20 min, or at least about 30 min.
26. The process of any of clauses 21-25, further comprising:
   treating the heart of palm with an effective amount of an acid selected from the group consisting of citric acid, acetic acid, fumaric acid, lactic acid, phosphoric acid, malic acid, tartaric acid, ascorbic acid, any derivatives thereof, or any combinations thereof, and wherein the puree has a pH from about 2 to about 7, or from about 3 to about 6, or from about 4 to about 5.
27. The process of any of clauses 21-26, further comprising:
   adding a fruit juice to the heart of palm, wherein the fruit is selected from the group consisting of citrus fruits, oranges, lemons, grapefruits, pomelos, limes, various true or hybrid cultivars thereof, and any combinations thereof.
28. The process of any of clauses 21-27, further comprising:
   treating the heart of palm with an effective amount of an enzyme preparation.
29. The process of clause 28, wherein the enzyme preparation comprises a hemicellulolytic enzyme preparation.
30. The process of any of clauses 28-29, wherein the enzyme preparation comprises a pectolytic enzyme preparation.
31. The process of any of clauses 29-30, wherein treating the heart of palm with an enzyme comprises heating the puree with the enzyme preparation at an elevated temperature.
32. A puree of palm heart made by a process, the process comprising:
   providing a heart of palm; and
   subjecting the heart of palm to a particle size reduction process, forming the puree thereof
33. The puree of clause 32, wherein the process further comprises homogenizing the formed puree.
34. The puree of any of clauses 32-33, wherein providing a heart of palm comprises:
   providing a harvested palm comprising a heart and a shell surrounding the heart;
   removing the shell from the heart; and
   chopping the heart into pieces in about 0.5 inch to about 3 inches.
35. The puree of clause 34, wherein providing a heart of palm further comprises:
   removing a bottom from the heart of palm.
36. The puree of any of clauses 32-35, further comprising treating the chopped heart of palm with boiling water for at least about 3 min, or at least about 5 min, or at least about 10 min, or at least about 15 min, or at least 20 min, or at least about 30 min.
37. The puree of any of clauses 32-36, wherein the process further comprises:
   treating the heart of palm with an effective amount of an acid selected from the group consisting of citric acid, acetic acid, fumaric acid, lactic acid, phosphoric acid, malic acid, tartaric acid, ascorbic acid, any derivatives thereof, or any combinations thereof, and wherein the puree has a pH from about 2 to about 7, or from about 3 to about 6, or from about 4 to about 5.
38. The puree of any of clauses 32-37, wherein the process further comprises:
   adding a fruit juice to the heart of palm, wherein the fruit is selected from the group consisting of citrus fruits, oranges, lemons, grapefruits, pomelos, limes, various true or hybrid cultivars thereof, and any combinations thereof.
39. The puree of any of clauses 32-38, wherein the process further comprises:
   treating the heart of palm with an effective amount of an enzyme preparation.
40. The puree of clause 39, wherein the enzyme preparation comprises a hemicellulolytic enzyme preparation.
41. The puree of any of clauses 39-40, wherein the enzyme preparation comprises a pectolytic enzyme preparation.
42. The puree of any of clauses 39-41, wherein treating the heart of palm with an enzyme preparation comprises heating the puree with the enzyme preparation at an elevated temperature.
43. The puree of any of clauses 32-42, wherein the puree has an average particle size from about 50 micron to about 1,000 micron, or from about 100 micron to about 800 micron, or from about 200 micron to about 600 micron, or from about 300 micron to about 500 micron.
44. The puree of any of clauses 32-43, wherein the puree has a viscosity from about 100 centipoises to about 5,000 centipoises, or from about 300 centipoises to about 4,000 centipoises, or from about 600 centipoises to about 3,000 centipoises, or from about 900 centipoises to about 2,000 centipoises, or from about 1,500 centipoises to about 2,500 centipoises.
45. The puree of any of clauses 32-44, wherein the puree has a Brix value from about 3° to about 10°, or from about 4° to about 9°, or from about 4° to about 7°, or from about 5° to about 7°.
46. The puree of any of clauses 32-45, wherein the puree has a total carbohydrates from about 2 g/100 g to about 20 g/100 g, or from about 3 g/100 g to about 18 g/100 g, or from about 4 g/100 g to about 16 g/100 g, or from about 5 g/100 g to about 14 g/100 g, or from about 5 g/100 g to about 10 g/100 g, or from about 5 g/100 g to about 8 g/100 g, or from about 5 g/100 g to about 6 g/100 g.
47. The puree of any of clauses 32-46, wherein the puree has a total fiber content from about 0.1 g/100 g to about 10 g/100 g, or from about 0.3 g/100 g to about 8 g/100 g, or from about 0.5 g/100 g to about 6 g/100 g, or from about 1 g/100 g to about 4 g/100 g, or from about 1.5 g/100 g to about 3 g/100 g, or from about 2 g/100 g to about 2.5 g/100 g.
48. The puree of any of clauses 32-47, wherein the puree has a solid content from about 1 wt % to about 50 wt %, or from about 2 wt % to about 40 wt %, or from about 3 wt % to about 30 wt %, or from about 4 wt % to about 20 wt %, or from about 5 wt % to about 15 wt %, or from about 6 wt % to about 10 wt %.
49. The foodstuff of any of clauses 32-48, wherein the puree has a reduced vegetable flavor compared with unprocessed palm heart.
50. A beverage comprising the puree according to any of clauses 32-49.
51. A foodstuff comprising the puree according to any of clauses 32-49.
52. The foodstuff of clause 51 being a baked foodstuff selected from the group consisting of wafer(s), cracker(s), cookie(s), cake(s), bread(s), muffin(s), extruded snack(s), cookies, and biscuit(s).

Although only exemplary embodiments of the present disclosure have been described in detail above, those skilled in the art will readily appreciate that many modifications are possible without materially departing from the novel teachings and advantages of this invention. Accordingly, all such modifications are intended to be included within the scope of this disclosure as defined in the following claims.

1. A foodstuff consisting of a puree of palm or palm heart.

2. The foodstuff of claim 1, wherein the palm is substantially free from palm shell or palm stem.

3. The foodstuff of claim 1, wherein the puree has an average particle size from about 50 micron to about 1,000 micron, or from about 100 micron to about 800 micron, or from about 200 micron to about 600 micron, or from about 300 micron to about 500 micron.

4. The foodstuff of claim 1, wherein the puree has a viscosity from about 100 centipoises to about 5,000 centipoises, or from about 300 centipoises to about 4,000 centipoises, or from about 600 centipoises to about 3,000 centipoises, or from about 900 centipoises to about 2,000 centipoises, or from about 1,500 centipoises to about 2,500 centipoises.

5. The foodstuff of claim 1, wherein the puree further comprises an acid selected from the group consisting of citric acid, acetic acid, fumaric acid, lactic acid, phosphoric acid, malic acid, tartaric acid, ascorbic acid, any derivatives thereof, or any combinations thereof.

6. The foodstuff of claim 1, wherein the puree has a pH from about 2 to about 8, or from about 3 to about 7, or from about 4 to about 6, or from about 4 to about 5.

7. The foodstuff of claim 1, wherein the puree has a total carbohydrates from about 2 g/100 g to about 20 g/100 g, or from about 3 g/100 g to about 18 g/100 g, or from about 4 g/100 g to about 16 g/100 g, or from about 5 g/100 g to about 14 g/100 g, or from about 5 g/100 g to about 10 g/100 g, or from about 5 g/100 g to about 8 g/100 g, or from about 5 g/100 g to about 6 g/100 g.

8. The foodstuff of claim 1, wherein the puree has a total fiber content from about 0.1 g/100 g to about 10 g/100 g, or from about 0.3 g/100 g to about 8 g/100 g, or from about 0.5 g/100 g to about 6 g/100 g, or from about 1 g/100 g to about 4 g/100 g, or from about 1.5 g/100 g to about 3 g/100 g, or from about 2 g/100 g to about 2.5 g/100 g.

9. The foodstuff of claim 1, wherein the puree has a solid content from about 1 wt % to about 50 wt %, or from about 2 wt % to about 40 wt %, or from about 3 wt % to about 30 wt %, or from about 4 wt % to about 20 wt %, or from about 5 wt % to about 15 wt %, or from about 6 wt % to about 10 wt %.

10. The foodstuff of claim 1, wherein the puree has a reduced vegetable flavor compared with raw palm.

11. A beverage comprising the puree according to claim 1.

12. The beverage of claim 11, further comprising a fruit juice, wherein the fruit is selected from the group consisting of citrus fruits, oranges, lemons, grapefruits, pomelos, limes, various true or hybrid cultivars thereof, and any combinations thereof.

13. A process for making a puree of a part of palm, the process comprising:
providing a heart of palm; and
subjecting the heart of palm to a particle size reduction process, forming a puree thereof.

14. The process of claim 13, further comprising homogenizing the formed puree.

15. The process of claim 13, wherein providing a heart of palm comprises:
providing a harvested palm comprising a heart and a shell surrounding the heart;
removing the shell from the heart; and
chopping the heart into pieces in about 0.5 inch to about 3 inches.

16. The process of claim 15, further comprising:
removing a bottom from the heart of palm.

17. The process of claim 13, further comprising treating the chopped heart of palm with boiling water for at least about 3 min, or at least about 5 min, or at least about 10 min, or at least about 15 min, or at least 20 min, or at least about 30 min.

18. The process of claim 13, further comprising:
treating the heart of palm with an effective amount of an acid selected from the group consisting of citric acid, acetic acid, fumaric acid, lactic acid, phosphoric acid, malic acid, tartaric acid, ascorbic acid, any derivatives thereof, or any combinations thereof, and wherein the puree has a pH from about 2 to about 7, or from about 3 to about 6, or from about 4 to about 5.

19. The process of claim 13, further comprising:
adding a fruit juice to the heart of palm, wherein the fruit is selected from the group consisting of citrus fruits, oranges, lemons, grapefruits, pomelos, limes, various true or hybrid cultivars thereof, and any combinations thereof.

20. The process of claim 13, further comprising:
treating the heart of palm with an effective amount of an enzyme preparation, wherein the enzyme preparation comprises a hemicellulolytic enzyme preparation, a pectolytic enzyme preparation, or both.
